(19) United States
(12) Patent Application Publication
(10) Pub. No.: US 2012/0312688 A1
(43) Pub. Date: Dec. 13, 2012

(54) CATION EXCHANGE MEMBRANE HAVING ENHANCED SELECTIVITY, METHOD FOR PREPARING SAME AND USES THEREOF

(75) Inventors: Thomas Berthelot, Les Ulis (FR); Xuan Tuan Le, Montreal (CA)

(73) Assignee: COMMISSARIAT A L'ENERGIE ATOMIQUE ET AUX ENERGIES ALTERNATIVES, Paris (FR)

(21) Appl. No.: 13/516,674

(22) PCT Filed: Dec. 16, 2010
(86) PCT No.: PCT/EP2010/070003

§ 371 Date: Aug. 23, 2012

(30) Foreign Application Priority Data
Dec. 18, 2009 (FR) 0959191

(51) Int. Cl. B01J 39/20; B01D 61/44; C08J 5/22

(52) U.S. Cl. 204/520; 521/27

(57) ABSTRACT

The present invention relates to a cation exchange membrane consisting in a polymeric matrix on the surface of which is(are) grafted at least one group of formula —R₁—(CH₂)ₘ—NR₂R₃ and/or at least one molecule bearing at least one group of formula —R₁—(CH₂)ₘ—NR₂R₃ wherein R₁ represents an aryl group; m represents 0, 1, or 3; R₂ and R₃, either identical or different, represent a hydrogen or an alkyl group.

The present invention relates to a method for preparing such a membrane and to its uses.

### TECHNICAL FIELD

The present invention relates to the field of ionic membranes and more particularly of cation exchange membranes.

More particularly, the present invention proposes a cation exchange membrane, the properties of which in terms of selectivity are improved, this improvement being due to a surface modification of the membrane.

The present invention also relates to a method for preparing such a cation-exchange membrane and to its different uses.

### STATE OF THE PRIOR ART

Ion exchange membranes which are polymeric matrices allowing selective transfer of charged species depending on their charge sign, transfer of cations in the case of cation exchange membranes (CEM), transfer of anions in the case of anion exchange membranes (AEM) [1].

Electrodialysis is an electromembrane technique where the transfer of ions through a permeable ion exchange membrane, is carried out under the effect of electric field. The essential property of a cation exchange membrane (CEM) or anion exchange membrane (AEM) is the selective permeation to cations or to anions through the membrane respectively. This anion/cation separation is also called “permselectivity”.

One of the most important applications of electrodialysis using ion exchange membranes is recovery of strong acids from hydrometallurgy effluents and metallization methods [2].

However, the rinsing waters of these methods are generally quite loaded with multivalent ions [3]. All these different industrial applications of electrodialyis in order to be relevant, require the use of cation exchange membranes which are specifically selective to monovalent cations.

As a reminder, the separation of ions of the same sign but of different valency is called <<preferential selectivity>>. In order to improve such a property, a new type of cation exchange membrane called <<a membrane with preferential selectivity>> or <<specific cation exchange membrane (SCEM)>> has been developed. The membranes may be made selectively more permeable to ions of low valency than to those of high valency as well as to more hydrated ions relatively to those which are less hydrated [4].

In order to obtain a property of selectivity to monovalent ions, two methods are mainly selected.

The first method consists in making a homopolar membrane (which only contains a single type of ion exchange site) by adjusting the synthesis parameters, such as the cross-linking degree so that, in contact with a mixed solution which contains ions of different valency, the flow of monovalent cations and notably of protons is greater than that of multivalent metal cations.

The second method consists in depositing a thin layer of an anion exchange material at the surface of the cation exchange membrane so as to generate positive charges which will act as an electrostatic barrier on divalent cations and will limit their penetration into the membrane [5].

It has been reported that the selectivity of divalent ions with respect to monovalent ions slowly decreases with the increase in the cross-linking degree in the sulfonic ion exchange membranes consisting of styrene and of divinylbenzene [6]. As compared with membranes of the condensation type, the increase in the cross-linking degree improves permselectivity to monovalent cations. However, the potential drop through the membrane gradually increases during electrodialysis and becomes capable of producing a concentration polarization at the membrane/solution interface [7].

For the last 20 years, chemical methods for modifying the surface of membranes with the goal of improving selectivity to monovalent ions have been studied many times [5,8-10]. These modifications involve the formation and/or the deposit of a polymer such as polyethyleneimine, polyaniline or polypyrrole on the surface of the membrane. Nevertheless, as polyethyleneimine is mainly maintained at the surface of the membrane by electrostatic interactions, detachment of this layer is inevitably observed during electrodialysis sequences even if it is possible to regenerate the polymer layer by electrodeposition. In the long run, the modified membrane is insufficiently stable [11]. This is why it is indispensable to contemplate stable covalent bonds between the positively charged layer and the cation exchange membrane.

Chemical modification of a commercial cation exchange membrane by forming sulfonamide bonds was reported in the article of Chamoulaud and Belanger [12]. A three-step chemical process is proposed in order to obtain a surface modified by a layer of quarternized amines.

Thus, in U.S. Pat. No. 5,840,192 [13] for the synthesis of bipolar membranes, the polymer film used is ethylenetetrafluorethylene (ETFE) with a thickness of 100 μm on which chemical grafting of styrene was achieved followed by cross-linking with vinyl benzene (DVB). The styrene group then undergoes a chlorosulfonation reaction in order to introduce SO₂Cl groups, followed by hydrolysis in order to obtain functional groups of the SO₃ type. At this stage, a cation exchange membrane is obtained. The originality of this work lies in the addition of a chemical step aiming at modifying the surface of the formed cationic membrane. The modification step consists in carrying out amination on the surface of the chlorosulfonated membrane by means of a diamine (3-dimethyl-aminopropylamine) at room temperature; the —SO₂Cl groups thereby form with the amine, sulfonamide bonds (Scheme 1).

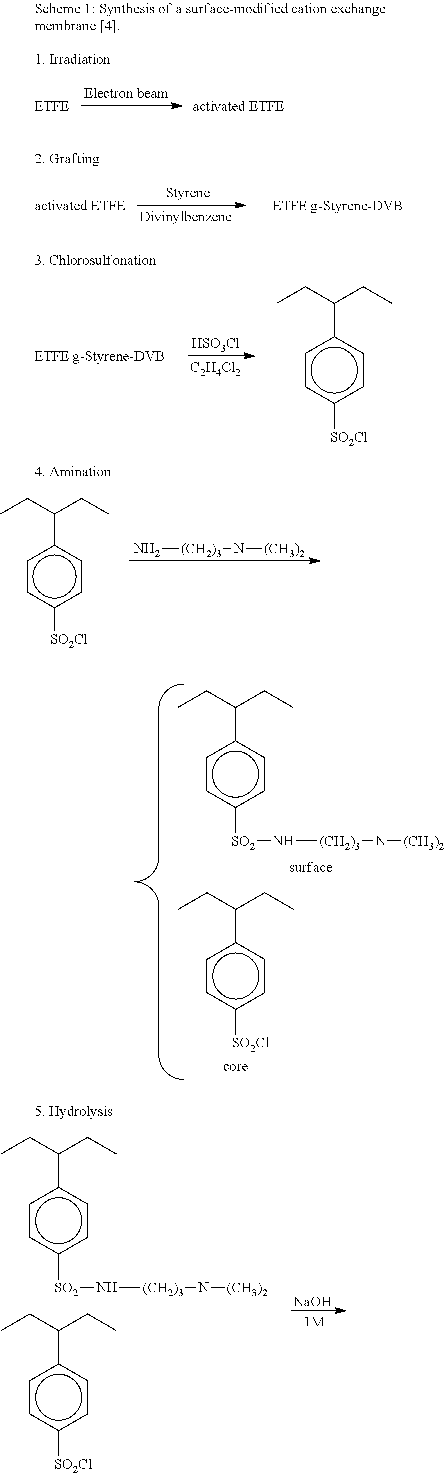

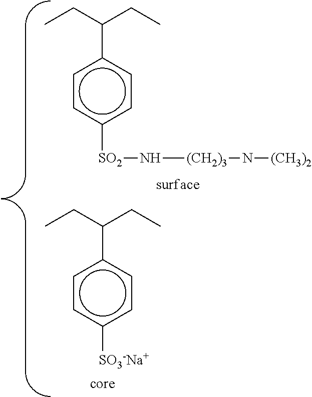

This covalent modification however caused chemical damage to the membrane which led to a reduction in the ion exchange capacities. Similarly, the PhD dissertation of Mrs Boulehid reported the difficulty of controlling the thickness of the additional layer modifying the surface of the membrane [4].

From work published in the literature, a reasonable interpretation is that the increase in the electric resistance of the membrane is dependent on the surface modifications and on the formation of the layers [14]. It was reported that the contraction of the membrane is 10 μm after chemical modification [11]. It was also reported that 35 μm deposits of polyaniline represent a too large size relatively to the total thickness of the virgin membrane of 80 μm [15]. In the field of membrane surface modification, beyond the improvement in the selectivity and stability of the performances, limitation of the increase in the resistance should be widely considered [14].

The experimental difficulty lies in obtaining a very thin aminated surface layer. Indeed, it is difficult to limit the reaction strictly to the surface while having a high surface grafting rate. Consequently, parameters such as the amination time and the concentration of the diamine have to be optimized. Working in 1,2-dichloroethane [13] which is a good organic solvent is not either a solution since it is then difficult under these conditions to limit the reaction strictly to the surface since the solvent can penetrate.

As explained earlier, there exists a real need for modified cation exchange membranes which have strong selectivity toward cations of different valency and which additionally preserve their ion exchange capacity and their electric resistance with view to a use in electrodialysis.

This need is closely related to an efficient method which allows modification of the cation exchange membranes via a layer grafted to the latter on the one hand and strict control of the thickness of the grafted layer on the other hand.

### DISCUSSION OF THE INVENTION

The present invention aims at providing a modified cation exchange membrane which meets the needs and the aforementioned technical problems.

Indeed, the work of the inventors allowed development of a method with which a modified cation exchange membrane may be obtained, having the following properties:

1) covalent chemical modification of the surface of this membrane in order to obtain permanent properties of the repellant layer even under difficult conditions of use;

2) highly superficial chemical modification, only affecting a little or not at all the thickness of the membrane and controlled in thickness, which does not modify or does not perturb the bulk properties of the membrane which should remain identical, for example, in order not to increase the overall electric resistance of the membrane;

3) generation of chemically non-hindered electrostatic charges so as to be efficient electrostatically;

4) large surface charge density related to a high grafting rate;

5) modification made in an simple chemical environment and under simple chemical conditions and during a single step.

More particularly, the present invention relates to a cation exchange membrane consisting in a polymeric matrix and notably a cation exchange polymeric matrix on the surface of which at least one group of formula —R₁—(CH₂)ₘ—NR₂R₃ and/or at least one molecule bearing at least one group of formula —R₁—(CH₂)ₘ—NR₂R₃ is(are) grafted, wherein:
R₁ represents an aryl group;
m represents 0, 1, 2 or 3;
R₂ and R₃, either identical or different represent a hydrogen or an alkyl group.

The invention benefits from the capability of cation exchange membranes of being functionalized, i.e. being modified at their surface by covalent grafting of chemical functions or polymer chains. It is this particular functionalization which guarantees the properties listed earlier of the cation exchange membrane according to the invention, designated as <<modified cation exchange membrane>> hereafter.

In the case when the cation exchange membrane according to the invention consists in a polymeric matrix on the surface of which is grafted at least one group of formula —R₁—(CH₂)ₘ—NR₂R₃, this group is bound to the applied cation exchange membrane in a covalent way, by a means of a bond involving an atom from the group R₁ (notably an atom of a (hetero)aromatic ring present in the group R₁) and an atom from the polymer matrix which forms this membrane.

By <<molecule bearing at least one group of formula —R₁—(CH₂)ₘ—NR₂R₃>>, is meant any natural or synthetic, advantageously organic molecule comprising from a few atoms to several tens or even hundreds of atoms. This molecule may therefore be a chemical function, a simple molecule or a molecule having a more complex structure such as a polymer structure.

Regardless of the structure of this molecule, the essential characteristics within the scope of the present invention are the fact that:
on the one hand, the molecule is bound to the applied cation exchange membrane in a covalent way, by means of a bond involving an atom of said molecule and an atom of the polymer matrix which forms this membrane, said molecule therefore comprises an atom (or a function) involved in the covalent bond with the surface of the polymeric matrix;
on the other hand, the molecule comprises a group of formula —R₁—(CH₂)ₘ—NR₂R₃.

It is clear for one skilled in the art that the group of formula —R₁—(CH₂)ₘ—NR₂R₃ is different from the function of the molecule involved in the covalent bond with the surface of the polymeric matrix.

By <<aryl group>> is meant, in order to define the group R₁ according to the present invention, an aromatic or heteroaromatic carbonaceous structure, optionally mono- or poly-substituted, consisting of one or more aromatic or heteroaromatic rings each including from 3 to 8 atoms, the heteroatom(s) may be N, O, P or S. The substituent(s) may contain one or more hetero-atoms, such as N, O, F, Cl, P, Si, Br or S as well as alkyl groups. Within the scope of the present invention, such a carbonaceous structure should bear at least one group of formula —(CH₂)ₘ—NR₂R₃ directly bound to one of its (hetero)aromatic rings.

Advantageously, the group R₁ according to the present invention is an aromatic or heteroaromatic ring including 6 atoms, the heteroatom(s) may be N, O, P or S, bearing a group of formula —(CH₂)ₘ—NR₂R₃ directly bound to one of the atoms of the ring and optionally substituted with one or more hetero-atoms, such as N, O, F, Cl, P, Si, Br or S as well as alkyl groups.

In particular, the group R₁ according to the present invention is a phenyl at least substituted with a group of formula —(CH₂)ₘ—NR₂R₃ directly bound to one of the phenyl atoms. The other optional substituent(s) is (are) a heteroatom, such as N, O, F, Cl, P, Si, Br or S or an alkyl group.

By <<alkyl group>> is meant in order to define groups R₂ and R₃ or the substituents of group R₁ according to present invention, a linear, cyclic or branched alkyl group optionally substituted, comprising from 1 to 6, notably from 1 to 4 carbon atoms and optionally a heteroatom such as N, O, F, Cl, P, Si, Br or S.

By <<substituted alkyl>>, is meant, within the scope of the present invention, an alkyl group substituted with a halogen, a methyl group, an ethyl group, an amine group or a diamine group.

The group —NR₂R₃ is a group capable, under the conditions of use of the cation exchange membrane according to the invention, of forming a cationic group which provides a positive charge to the surface of the cation exchange membrane. These positively charged groups are intended to preferentially repel multivalent ions relatively to monovalent ions. Therefore, the group —NR₂R₃ gives the possibility of imparting to the membrane grafted with a molecule bearing such a group, improved selectivity towards monovalent ions over multivalent ions, relatively to the selectivity of the virgin membrane, i.e. non-grafted membrane.

Advantageously, the groups R₂ and R₃, either identical or different, are selected from the group consisting of a hydrogen, a methyl, an ethyl or a propyl. More particularly, the groups R₂ and R₃ are identical. Still more particularly, the groups R₂ and R₃ represent a hydrogen.

In an advantageous alternative, the group of formula —(CH₂)ₘ—NR₂R₃ substituting the aryl group R₁ is advantageously selected from the group consisting of —NH₂, —CH₂—NH₂, —(CH₂)₂—NH₂, —N(CH₃)₂, —CH₂—N(CH₃)₂, —(CH₂)₂—N(CH₃)₂, —N(C₂H₅)₂, —CH₂—N(C₂H₅)₂ and —(CH₂)₂—N(C₂H₅)₂.

The group of formula —(CH₂)ₘ—NR₂R₃ substituting the aryl group R₁ is in particular selected from the group consisting of —NH₂, —CH₂—NH₂ and —(CH₂)₂—NH₂.

The group of formula —(CH₂)ₘ—NR₂R₃ substituting the aryl group R₁ is more particularly —NH₂. Indeed, —NH₂ groups give, under the conditions of use of the cation exchange membrane according to the invention, —NH₃⁺ groups of small size rather than big quaternary ammonium ions. In this case, the electrostatic fields decrease as a function of the inverse square of the distance (1/r²) and are therefore more intense upon approaching them as close as possible.

In an alternative of the present invention, the molecule grafted on the surface of the cation exchange membrane according to the invention is a polymeric structure. Advantageously, this polymeric structure is a polymer or a (co)polymer mainly derived from several monomer units, either identical or different, said polymer or co-polymer bearing at least one group of formula —R₁—(CH₂)ₘ—NR₂R₃ as defined earlier.

In particular, this polymeric structure is a (co)polymer mainly stemming from several monomer units, either identical or different, bearing at least one group of formula —R₁—(CH₂)ₘ—NR₂R₃ as defined earlier. Still more particularly, this polymeric structure is a (co)polymer mainly stemming from several monomeric units, either identical or different, of formula —R₁[(CH₂)ₘ—NR₂R₃]— as defined earlier. In this scenario, the monomer units are bound to each other via groups R₁ and advantageously by a covalent bond between two atoms, each borne by an aromatic ring of groups R₁ of two distinct monomers.

Whether the cation exchange membrane according to the invention is grafted with a group of formula —R₁—(CH₂)ₘ—NR₂R₃ and/or with a molecule bearing at least such a group notably in the form of a polymeric structure, the thickness of the grafting i.e. the thickness of the thereby grafted layer is less than 100 nm, advantageously less than 80 nm, notably less than 60 nm and, in particular, comprised between 2 nm and 40 nm and, more particularly, comprised between 3 nm and 30 nm.

By [symbol] polymeric matrix [symbol] is meant the base portion of the cation exchange membrane which gives the shape to the latter and the cation exchange nature.

Any polymeric matrix commonly used for a cation exchange membrane may be used within the scope of the present invention. The polymeric matrix applied may be a commercial polymeric matrix such as a Selemion CMV membrane matrix (Asahi Glass, Japan), a Neosepta CMX membrane matrix (Tokuyama Soda, Japan) or a CMI-70005 matrix (Membrane International Inc., USA).

This polymeric matrix has ionic groups, either identical or different, capable of giving it its permselectivity. These ionic groups are notably selected from —SO₃⁻, —PO₃²⁻, —HPO₂⁻, —COO⁻, —SeO₃²⁻ and —AsO₃²⁻.

Advantageously, this polymeric matrix has a thickness comprised between 1 μm and 1 cm, notably between 2 μm and 500 μm and, in particular, between 5 μm and 150 μm.

One skilled in the art is aware of different techniques allowing preparation of such a polymeric matrix.

Thus, this technique may be a chemical method during which a polymer including aromatic rings is functionalized with ionic groups as defined earlier or with groups comprising one or several ionic groups as defined earlier. A polymer including aromatic rings may be, as non-limiting examples, polyaryletheretherketone (PEEK), styrene-divinylbenzene, styrene-butadiene, styrene-isoprene-styrene or styrene-ethylene/butylene-styrene.

Alternatively, this technique may involve a radiochemical step followed by a chemical step complying with the chemical method as described earlier. The radiochemical step consists in grafting, under the influence of gamma, X or electron radiation, an aromatic compound on an inert polymer. An aromatic compound which may be used is notably a polymer including aromatic rings, as defined earlier. An inert polymer may be, as non-limiting examples, a polyurethane, a polyolefin, a polyethylene terephthalate, a polycarbonate, polyethylene, a fluorinated polymer such as poly(vinylidene fluoride) or polytetrafluoroethylene, a polyamide or polyacrylonitrile.

The polymeric matrix which may be used within the scope of the present invention may be nanostructured and notably comprise, in its thickness, substantially cylindrical areas, such as channels, which advantageously join up with two opposite faces of the matrix.

This nanostructuration may increase the selectivity already obtained with the grafting, subject-matter of the present invention. Indeed, these substantially cylindrical zones give the possibility of promoting the passing of cations having a small diameter unlike the cations with larger diameters.

These substantially cylindrical areas crossing the polymeric matrix comprise polymeric chains covalently bound to the polymer forming the matrix and selected from:
polymeric chains comprising a main chain, at least one portion of the carbon atoms of which is bound both to a —COOR group and to a —SO₃R or —PO₃R₂ group, R representing a hydrogen, a halogen, an alkyl group or a cationic counter-ion;
polymeric chains comprising a main chain comprising pendant phenyl groups, at least one portion of these groups of which comprises at least one hydrogen atom substituted with a —SO₃R or —PO₃R₂ group, R having the same meaning as the one given above, and
mixtures thereof.

These substantially cylindrical zones may cross the thickness of the polymeric matrix with variable or identical angles. They may have a diameter ranging from 10 to 100 nm (nanozones). These zones may also be hollow, in which case the grafts are bound on the wall of said zones. Conventionally, the polymeric matrix may comprise from 5.10⁴ to 5.10¹⁰, preferably from 10⁵ to 5.10⁹ zones per cm².

Such a nanostructured polymeric matrix has 1) large ion exchange capacity; 2) capability of ensuring proton conduction at operating temperatures above 80° C., for example 120° C.; 3) resistance to pressures of 10 bars; 4) inertia towards corrosion phenomena.

A nanostructured polymeric matrix is advantageously a matrix in an inert polymer as defined earlier, notably a matrix in a fluorinated inert polymer and, in particular in PVDF.

The polymeric chains bound to the constitutive polymer of the polymeric matrix may appear in various forms.

Thus, according to a first embodiment, the polymeric chains comprise a main chain, at least one portion of the carbon atoms of which is bound both to a —COOR group and to a —SO₃R or —PO₃R₂ group, which means in other words that some of the carbon atoms of the main chain are dually substituted, one of the substituents being a —COOR while the other substituent is a —SO₃R or —PO₃R₂. This does not exclude the fact that the carbon atoms adjacent to those bearing the —COOR group may also comprise —SO₃R or —PO₃R₂.

Such polymeric chains may result from the polymerization of acrylic monomers including at least one —CO₂R group, such as acrylic acid, the resulting polymers having undergone a sulfonation or phosphanation step in order to introduce the —SO₃R or —PO₃R₂ groups on at least one portion of the atoms bearing —CO₂R groups, R being as defined above.

According to a second embodiment, the polymeric grafts comprise a main chain comprising pendant phenyl groups, at least one portion of these groups of which comprises at least one hydrogen atom substituted with a —SO₃R or —PO₃R₂ group, R being as defined above.

Such polymeric chains may result from the polymerization of monomers including aromatic rings followed by a sulfonation or phosphanation step so as to introduce on at least one of the carbon atoms of the phenyl groups, a —SO₃R or —PO₃R₂ group, R being as defined above. The polymeric chains obtained following the polymerization step are polymers including aromatic rings as defined earlier.

Any technique allowing the preparation of a nanostructured polymeric matrix may be used within the scope of the present invention.

Advantageously, the preparation method of the invention may comprise the following steps:

i) a step for irradiation of a polymeric matrix, so as to form irradiated zones with a substantially cylindrical shape crossing the thickness of the matrix;

ii) optionally a step for revealing the latent traces generated by the irradiation step;

iii) a step for grafting the irradiated zones by a radical reaction with an ethylenic monomer, by means of which the main chain of the polymeric chains is obtained;

iv) a step for sulfonation or phosphanation of said main chains.

The step (i) for irradiation of a polymeric matrix may consist in subjecting said matrix to bombardment with heavy ions notably selected from krypton, lead and xenon.

More particularly, this step may consist in bombarding the polymeric matrix with a beam of heavy ions, such as a beam of Pb ions with an intensity of 4.5 MeV/mau or a beam of Kr ions with an intensity of 10 MeV/mau.

From a mechanistic point of view, when the energy-bearing heavy ion crosses the matrix, its velocity decreases. The ion yields its energy, by generating damaged areas, the shape of which is approximately cylindrical. These areas are called <<latent traces>> and comprise two regions: the core and the halo of the trace. The core of the trace is a totally degraded area, i.e. an area where there has been breakage of the constitutive bonds of the material generating free radicals. This core is also the region where the heavy ion transmits a considerable amount of energy to the electrons of the material. And then, from this core, there is an emission of secondary electrons, which will cause defects far from the core, thereby generating a halo.

The irradiation step may also be achieved by UV irradiation or electron irradiation, however, subject to the use of a mask delimiting the substantially cylindrical zones to be generated by the irradiation.

The method for preparing a nanostructured polymeric matrix may comprise, after the irradiation step, a step (ii) for revealing latent traces generated by the irradiation step. Chemical development may consist in putting the matrix in contact with a reagent capable of hydrolyzing the latent traces, so as to form hollow channels in the place of the latter.

According to this particular embodiment, following irradiation of the polymeric matrix with heavy ions, the generated latent traces have short chains of polymers formed by the splitting of the existing chains while the ion passes into the material during irradiation. In these latent traces, the hydrolysis rate during the development is greater than that of the non-irradiated portions. Thus, it is possible to proceed with selective development. The reagents which may ensure the development of latent traces depend on the constitutive material of the matrix.

Thus, the latent traces may notably be treated with a strongly basic and oxidizing solution, such as a 10N KOH solution in the presence of KMnO₄ at 0.25% by weight at a temperature of 65° C., when the polymeric matrix for example consists of a fluorinated polymer. A treatment with a basic solution, optionally coupled with sensitization of the traces by UV, may for example be sufficient for polymers such as polyethylene terephthalate (PET) and polycarbonate (PC). The treatment leads to the formation of cylindrical hollow pores, the diameter of which may be modulated depending on the etching time with the basic and oxidizing solution. Generally, irradiation with heavy ions will be carried out so that the membrane includes a number of traces per cm² comprised between 10⁶ and 10¹¹, notably between 5.10⁷ and 5.10¹⁰ and, in particular of the order of 10¹⁰.

The method for preparing a nanostructured polymeric matrix then comprises a grafting step (iii) consisting in putting the irradiated and optionally developed matrix in contact with an ethylenic monomer.

Without being bound by theory, the step for grafting the ethylenic monomer may take place in three phases:
a reaction phase of the ethylenic monomer at the aforementioned zones, this initiation phase being materialized by opening of the double bond by reaction with a radical centre of the matrix, the radical centre thereby <<moving>> from the matrix towards a carbon atom from said ethylenic monomer;
a phase for polymerization of the ethylenic monomer from the radical centre generated on the first grafted monomer;
a termination phase by radical recombination or transfer according to the environment of the reaction medium.

In other words, the free radicals present within the aforementioned zones generate propagation of the polymerization reaction of the ethylenic monomer put into contact with the matrix. The radical reaction is thus, in this scenario, a radical polymerization reaction of the ethylenic monomer put into contact, from the irradiated matrix.

At the end of the polymerization phase, the obtained membranes will thus comprise a polymeric matrix grafted by polymers comprising recurrent units from the polymerization of the ethylenic monomer put into contact with the irradiated matrix.

After the grafting step (iii), the method of the invention finally comprises a sulfonation or phosphanation step (step iv).

The sulfonation step consists in introducing a sulfonic group —SO₃R into a molecule by a direct carbon-sulfur bond. The sulfonation may occur by a direct sulfonation reaction (addition reaction), a reaction for substituting a halogen atom or a diazoic group with a sulfonic group, a reaction for oxidation of a sulfide group. This sulfonation step may consist in treating the grafted matrix with a solution of chlorosulfonic acid.

The phosphanation step consists in introducing a phosphonic group —PO₃R₂ into a molecule, by a direct carbon-phosphorus bond. Such a step may be achieved with a Michaelis-Arbuzov or Michaelis-Becker reaction on a molecule bearing a halogen atom thereby leading to the formation of phosphonic acid ester, followed by optional hydrolysis in order to obtain the corresponding phosphonic acid. For molecules including aryl groups, such a step may be achieved with a Friedel-Craft reaction followed by optional hydrolysis leading to the corresponding phosphonic acid.

The present invention also relates to the use of a cation exchange membrane, modified according to the present invention. Indeed, the latter because of the presence of a grafted layer at its surface, a layer bearing groups of formula —R₁—(CH₂)ₘ—NR₂R₃ capable of forming cationic groups which repel multivalent cations and notably bivalent cations such as Ni²⁺, Ca²⁺, Pb²⁺, Cu²⁺, Ti²⁺ or Zn²⁺, is selectively permeable to monovalent cations and notably to alkaline cations. As examples of optionally alkaline monovalent cations, mention may be made of H⁺, Na⁺, K⁺ and Li⁺.

The grafting of a layer bearing groups of formula —R₁—(CH₂)ₘ—NR₂R₃ at the surface of the cation exchange membrane according to the invention allows an increase in the mobility ratio X⁺/Yⁿ⁺ with X⁺, Vⁿ⁺ and n a monovalent cation, a multivalent cation and an integer greater than or equal to 2, respectively; notably in the mobility ratio X⁺/Y²⁺ and in particular, in the mobility ratio H⁺/Ni²⁺. This increase may be by a factor greater than 2, greater than 3, greater than 4 or even greater than 5 relatively to the corresponding mobility ratio, obtained for the cation exchange membrane not having been subject to a modification according to the present invention, i.e. a virgin membrane. In return, the grafting of a layer bearing groups of formula —R₁—(CH₂)ₘ—NR₂R₃ does not modify the ion exchange capacity of the modified membrane relatively to the virgin membrane.

By this selectivity, the cation exchange membrane according to the present invention is useful for electrodialysis of a solution [1].

This solution is advantageously selected from the group formed by brackish water, spring water, drinking water, sea water, an industrial effluent, a solution from the agrifood industry or a solution from fine chemical industry or pharmaceutical industry.

Indeed, the cation exchange membrane according to the present invention may be used not only for producing drinking water from brackish water or sea water but also for removing possible contaminants of the metal cation type or for reducing the load thereof in drinking water or spring water.

Further, the cation exchange membrane according to the present invention may be used for treating industrial effluents by electrodialysis and this notably for removing possibly toxic heavy metals therefrom which they may contain. These industrial effluents may stem from the paper industry, hydrometallurgical industry, surface treatment industry or tanning industry.

In the field of the agrifood industry, electrodialysis involving a cation exchange membrane according to the present invention may be used for demineralizing lactoserum; for deacidifying and/or demineralizing fruit juices and sweet solutions; for producing organic acids.

Finally, in the field of fine chemistry and pharmacy, a cation exchange membrane according to the present invention may be used for purifying pharmaceutical active ingredients or amino acids; for preparing isotonic solutions; for producing organic acids, for concentrating acids.

The present invention also relates to a method for preparing a cationic exchange membrane as defined earlier.

The method of the present invention consists in grafting on a polymeric matrix as described earlier, at least one group of formula —R₁—(CH₂)ₘ—NR₂R₃ and/or at least one molecule bearing at least one such group.

Any grafting technique known to one skilled in the art may be used within the scope of the present invention. However, a technique which is advantageously applied is the one described in international application WO 2008/078052 [16], this technique involving chemical radical grafting.

The term of [symbol] chemical radical grafting [symbol] notably refers to the use of molecular entities having an unpaired electron for forming bonds of the covalent bond type with the surface of the polymeric matrix of the membrane, said molecular entities being generated independently of the surface on which they are intended to be grafted.

The use of chemical radical grafting for grafting and modifying a cation exchange membrane has several advantages over the grafting techniques used in the state of the art and notably in [4,12,13].

Indeed, chemical radical grafting as described in [16] allows covalent grafting in a simple step, by adding the material to the polymeric matrix and not by modifying it.

Further, the chemical radical grafting as described in [16] is controlled and controllable in thickness by which it is possible to avoid a reduction of the resistance and/or the production of a bipolar membrane effect.

As chemical radical grafting involves radical species, strongly reactive species which bind to the surface of the matrix before having been able to penetrate into the thickness of the latter, there are no perturbations of the bulk properties and therefore of the electric resistance of the polymeric matrix.

Finally, the radical species generated during chemical radical grafting may react with any reactive group of the polymeric matrix which gives the possibility of having a large population of sites on which grafting may take place and of thereby obtaining a substantial charge density. In the method described in [4, 12, 13], 3-dimethylaminopropylamine only reacts with the chlorosulfonated groups which themselves depend on the initial population of styrene groups themselves depending on the initial grafting level. By using a polymeric matrix of the type of the one described in [4, 12, 13], the generated radical species during the chemical radical grafting may bind both onto the chlorosulfonated styrene groups, the non-chloro-sulfonated styrene groups and any other reactive group present at the surface of the membrane. By <<reactive group>> is meant a group which may react with a radical centre.

The method for preparing a cation exchange membrane according to the present invention advantageously consists in having a cleavable aryl salt bearing at least one group of formula —(CH₂)ₘ—NR₂R₃ with m, R₂ and R₃ as defined earlier, directly bound to a (hetero)aromatic ring on the polymeric matrix as defined earlier, by chemical radical grafting.

The cleavable aryl salt applied, selected from the group consisting of aryl diazonium salts, aryl ammonium salts, aryl phosphonium salts and aryl sulfonium salts, said aryl group bearing at least one group of formula —(CH₂)ₘ—NR₂R₃ with m, R₂ and R₃ as defined earlier, directly bound to a (hetero)aromatic ring. In these salts, the aryl group is an aryl group which may be represented by R₁ as defined earlier.

Among cleavable aryl salts, mention may in particular be made of the compounds of the following formula (I):

R₂R₃N—(CH₂)ₘ—R₁—N₂⁺,A⁻ (I)

wherein:
A represents a monovalent anion and
m, R₁, R₂ et R₃ are as defined earlier.

Within the compounds of formula (I) above, A may notably be selected from inorganic anions such as halides like I⁻, Br⁻ and Cl⁻, halogenoborates such as tetrafluoroborate, perchlorates and sulfonates and organic anions such as alcoholates and carboxylates.

As compounds of formula (I), it is particularly advantageous to use 4-aminophenyldiazonium tetrafluoro-borate or 4-aminomethylphenyldiazonium chloride.

Thus, this grafting step consists in subjecting, optionally in the presence of at least one polymeric matrix as defined earlier, a solution S containing at least one cleavable aryl salt bearing at least one group of formula —(CH₂)ₘ—NR₂R₃ with m, R₂ and R₃ as defined earlier, directly bound to a (hetero)aromatic ring or a precursor of such a cleavable aryl salt, to conditions allowing the formation of at least one radical entity from said cleavable aryl salt or said precursor.

By [symbol] precursor of a cleavable aryl salt bearing at least one group of formula —(CH₂)ₘ—NR₂R₃ directly bound to (hetero)aromatic ring [symbol] , is meant within the scope of the present invention, a molecule separated from said cleavable aryl salt by an operating step single and easy to apply.

Generally, the precursors have greater stability than the cleavable aryl salt under the same environmental conditions. For example, aryl amines are precursors of aryl diazonium salts. Indeed, by a simple reaction, for example with NaNO₂ in an acid aqueous medium, or with NOBF₄ in an organic medium, it is possible to form the corresponding aryl diazonium salt.

A precursor advantageously applied within the scope of the present invention is a precursor of aryl diazonium salts, of the following formula (II):

R₂R₃N—(CH₂)ₘ—R₁—NH₂ (II),

R₁, R₂, R₃ and m being as defined earlier.

As non-limiting examples, a precursor which may be applied within the scope of the present invention is 4-aminophenylamine (or p-phenylenediamine) or 4-amino-methylphenylamine.

The solution S applied in the grafting step of the method according to the present invention contains, as a solvent, a solvent which may be:
either a protic solvent, i.e. a solvent which includes at least one hydrogen atom which may be released as a proton and advantageously selected from the group consisting of water, deionized water, distilled water, either acidified or basic, acetic acid, hydroxylated solvents such as methanol and ethanol, liquid glycols of low molecular weight such as ethylene glycol, and mixtures thereof;
or an aprotic solvent, i.e. a solvent which is unable to release a proton or to accept one under non-extreme conditions and advantageously selected from dimethylformamide (DMF), acetone, acetonitrile and dimethyl sulfoxide (DMSO);
or a mixture of at least one protic solvent and of at least one aprotic solvent.

The conditions allowing the formation of at least one radical entity in the grafting step of the method of the present invention are conditions which allow the formation of radical entities in the absence of the application of any electric voltage to the reaction mixture comprising a solvent, at least one polymeric matrix, at least one cleavable aryl salt bearing at least one group of formula —(CH₂)ₘ—NR₂R₃ directly bound to a (hetero)aromatic ring or a precursor of such a cleavable aryl salt.

These conditions involve parameters such as for example the temperature, the nature of the solvent, the presence of a particular additive, the stirring, the pressure while the electric current is not involved during the formation of the radical entities. The conditions allowing the formation of radical entities are numerous and this type of reaction is known and studied in detail in the prior art.

Thus it is for example possible to act on the thermal, kinetic, chemical, photochemical or radiochemical environment of a cleavable aryl salt bearing at least one group of formula —(CH₂)ₘ—NR₂R₃ directly bound to a (hetero)aromatic ring or of a precursor of such a salt in order to destabilize it so that it forms a radical entity. Of course it is possible to simultaneously act on several of these parameters.

Within the scope of the present invention, the conditions allowing the formation of radical entities during the grafting step according to the invention are typically selected from the group consisting of thermal conditions, kinetic conditions, chemical conditions, photochemical conditions, radiochemical conditions and combinations thereof, to which the molecule or its precursor are subject. Advantageously, the conditions applied within the scope of the grafting step according to the present invention are selected from the group consisting of thermal conditions, chemical conditions, photochemical conditions, radiochemical conditions and combinations thereof and/or with kinetic conditions. The conditions applied within the scope of the grafting step of the method according to the present invention are more particularly chemical conditions.

The thermal environment depends on temperature. Its control is easy with heating means customarily used by one skilled in the art. The use of a thermostatic environment is of particular interest since it allows accurate control of the reaction conditions.

The kinetic environment essentially corresponds to the stirring of the system and to the frictional forces. Here, this is not the agitation of the molecules per se (elongation of bonds, etc), but the overall motion of the molecules.

Thus, during said grafting step, the solution S is subject to mechanical stirring and/or to treatment with ultrasonic waves. In a first alternative, the solution S implemented during the grafting step is subject to a high speed of rotation by means of a magnetic stirrer and of a magnetized bar and this, for a duration comprises between 5 mins and 24 hours of stirring, notably comprised between 10 mins and 12 hours and, in particular, between 15 mins and 6 hours. In a second alternative, the solution S applied during the grafting step is subject to a treatment with ultrasonic waves, notably by using an ultrasonic pan, typically with an absorption power of 500 watts and a frequency of 25 or 45 kHz and this, for a duration comprised between 1 min and 24 hours of stirring, notably comprised between 15 mins and 12 hours and, in particular between 30 mins and 6 hours.

Finally, the action of various radiations such as electromagnetic radiations, γ radiations, UV rays, electron or ion beams may also sufficiently destabilize the cleavable aryl salt bearing at least one group of formula —(CH₂)ₘ—NR₂R₃ directly bound to a (hetero)aromatic ring so that it forms radicals. The wavelength used will be selected without any inventive effort, according to the cleavable aryl salt used.

Within the scope of the chemical conditions, one or several chemical initiators are used in the reaction medium i.e. the solution S. The presence of chemical initiators is often coupled with non-chemical environmental conditions, as discussed above. Typically, a chemical initiator, the stability of which is lower than that of the cleavable aryl salt or of the precursor applied under the selected environmental conditions will develop in an unstable form which will act on the latter and will generate from them the formation of radical entities. It is also possible to use chemical initiators, the action of which is not essentially related to the environmental conditions and which may act over vast ranges of thermal or even kinetic conditions. The initiator will preferably be adapted to the environment of the reaction, for example to the solvent used.

There exist many chemical initiators. Generally, a distinction is made between three types depending on the environmental conditions used:
thermal initiators, the most common of which are peroxides or azoic compounds. Under the action of heat, these compounds dissociate into free radicals. In this case, the reaction is carried out at a minimum temperature corresponding to that required for forming radicals from the initiator. This type of chemical initiators is generally specifically used in a certain temperature interval, depending on their decomposition kinetics;
photochemical or radiochemical initiators which are excited by radiation triggered by irradiation (most often by UV, but also by γ radiations or by electron beams) allow the production of radicals by more or less complex mechanisms. Bu₃SnH and I₂ belong to photochemical or radiochemical initiators;
essentially chemical initiators, this type of initiators acting fast and under normal temperature and pressure conditions on the molecule or its precursor in order to allow it to form radicals. Such initiators generally have an oxidation-reduction potential which is less than the reduction potential of the cleavable aryl salt or said precursor used under the reaction conditions. Depending on the nature of the cleavable aryl salt or on its precursor, this may thus be for example a reducing metal, such as iron, zinc, nickel; a metallocene; an organic reducing agent such as hypophosphorous acid (H₃PO₂) or ascorbic acid; an organic or inorganic base in sufficient proportions in order to allow destabilization of the cleavable aryl salt or of its precursor. Advantageously, the reducing metal used as a chemical initiator appears in a finely divided form such as metal wool (also more commonly called <<flakes>>) or metal filings. Generally, when an organic or inorganic base is used as a chemical initiator, a pH greater than or equal to 4 is generally sufficient. Structures of the radical reservoir type, such as polymeric matrices irradiated beforehand with an electron beam or a heavy ion beam and/or with the whole of the irradiation means mentioned earlier, may also be used as chemical initiators for destabilizing the cleavable aryl salt or its precursor and leading to the formation of radical entities from this salt.

More particularly, the method according to the invention comprises the following steps:

a) optionally converting a precursor of a cleavable aryl salt bearing at least one group of formula —(CH₂)ₘ—NR₂R₃ directly bound to a (hetero)aromatic ring present in a solution S into said corresponding cleavable aryl salt;

b) subjecting a cleavable aryl salt bearing at least one group of formula —(CH₂)ₘ—NR₂R₃ directly bound to a (hetero)aromatic ring, optionally obtained following step (a), present in a solution S, under non-electrochemical conditions so as to generate a radical entity from said cleavable aryl salt;

c) applying the polymeric matrix as defined earlier in contact with the radical entity obtained in step (b) present in said solution S, thereby grafting of a group of formula —R₁—(CH₂)ₘ—NR₂R₃ and/or of a polymeric structure bearing at least such a group on said polymeric matrix is achieved, m, R₁, R₂ and R₃ being as defined earlier.

Scheme 2 hereafter shows the steps of such a method which uses as a precursor p-phenylenediamine.

The amount of cleavable aryl salt or of the precursor of this cleavable aryl salt in the solution S may vary according to the desire of the experimenter.

This amount is advantageously comprised, within the solution S, between 10⁻⁶ and 5 M approximately, preferably between 5.10⁻² and 10⁻¹ M.

The step (c) of the method according to the present invention corresponds to the grafting step as defined earlier. It may last from 10 mins to 6 hours, notably from 30 mins to 4 hours, in particular from 1 to 2 hours, and more particularly about 90 mins (±10 min).

As the cleavable aryl salt or the precursor of this cleavable aryl salt is present in a large amount in the solution S, the grafting step may be stopped before all the molecules are attached on the carbon nanotubes. One skilled in the art is aware of different techniques allowing the stopping of the grafting step and will know how to determine the most suitable technique depending on the cleavable aryl salt or on its applied precursor. As examples of such techniques, mention may be made of changing the pH of the solution S notably by adding a basic solution thereto (for example, basic water with a pH above 10), of removing the cleavable aryl salt in the solution S (for example by filtration, by precipitation or by complexation) or of withdrawing the polymeric matrix from the solution S.

Other features and advantages of the present invention will further become apparent to one skilled in the art upon reading the examples given below as an illustration and not as a limitation, with reference to the appended figures.

### SHORT DESCRIPTION OF THE DRAWINGS

FIG. 1 is a schematic illustration of the mercury cell which may be used for measuring the membrane resistance.

FIG. 2 shows scanning electron microscopy (SEM) images of the surface (FIGS. 2A and 2B) and of the section (FIGS. 2C and 2D) of the virgin membranes (FIGS. 2A and 2C) and modified (FIGS. 2B and 2D).

FIG. 3 shows the infrared spectra of the virgin membrane VMC (curve (a)) and of the membrane VMC modified by a thin layer of the polyaniline type (curve (b)).

FIG. 4 shows the X photoelectron spectrometry spectra (XPS) of the virgin membrane VMC (curve (a)) and of the membrane VMC modified by a thin layer of the polyaniline type (curve (b)).

FIG. 5 shows the X photoelectron spectrometry spectra (XPS) of the virgin PVDF membrane (FIG. 5A), of the PVDF membrane modified with PAA (FIG. 5B) and modified by a thin layer of the polyaniline type (FIG. 5C).

FIG. 6 shows the impedance diagram recorded on the virgin membrane VMC (triangles) and of the membrane VMC modified by a thin layer of the polyaniline type (squares).

FIG. 7 shows the fraction of nickel ions in equivalents in the modified membrane versus the nickel equivalent concentration in the equilibration solution (curve a) and the conductivity of the modified membrane (curve b).

FIG. 8 shows the change in the conductivity of the membrane versus the equivalent fraction of nickel ions in the modified membrane.

### DETAILED DISCUSSION OF PARTICULAR EMBODIMENTS

### I. Cation Exchange Membranes

I.1. VMC Membrane.

The main characteristics of the cation exchange membrane VMC used in this work are given in Table 1.

TABLE 1
properties of the VMC membrane [17].

| | Selemion |
|---|---|
| Name | VMC |
| Type | Cation |
| Thickness (mm) | 0.140-0.145 |
| Water content (%) | 18-28 |
| Active structure | PS/DVB |
| H⁺ transport index | 1.00 |
| Charged group | Sulfonate |
| Structural base | PVC |
| Dry membrane density | 1.15 ± 0.10 |
| ρ_{d} (g/cm³) | |
| Wet membrane density | 1.20 ± 0.10 |
| ρₘ (g/cm³) | |

I.2. Radiografted Nanostructured Membranes.

I.2.1. Heavy Ion Irradiation Procedure.

A PVDF β membrane (thickness 9 μm, Solvay-Belgium) was extracted with a sohxlet in toluene for 24 hours. Subsequently, the membrane was dried in vacuo at 60° C. for 12 hours. The membrane was then subject to irradiation with heavy ions ₇₈Kr³¹⁺ (Kr=10 MeV·amu⁻¹, the electron stopping power of Kr being 40 MeV·cm²·mg⁻¹) at a fluence of 10¹² ions/cm² (Ganil, Caen) in a helium atmosphere. The membrane was stored under a nitrogen atmosphere and at −20° C. until it is used.

I.2.2. Radiografting Procedure with Styrene.

A membrane irradiated with heavy ions (point I.2.1) is immersed in a pure styrene solution in a radiografting tube and then nitrogen bubbling is carried out for 30 mins. The tube is subsequently sealed and is placed in a bath at 60° C. for 1 hour. The thereby modified membrane is rinsed twice with toluene (2×100 mL). The membrane was dried in vacuo for 2 hours.

The radiografting rate was calculated with the following ratio: Y_{w}=(W_{f}−Wᵢ)/Wᵢ (%) wherein W_{f} and Wi represent the weight of the membrane after and before grafting of the vinyl monomer. The radiografting rate was determined as being 140% by mass. The membrane was analyzed by Fourier transform infrared spectrometry in the ATR (Attenuated Total Reflection) mode. The specific vibration bands of polystyrene at 2,985 cm⁻¹ and at 3,025 cm⁻¹ were observed.

I.2.3. Radiografting Procedure with Acrylic Acid.

A membrane irradiated with heavy ions (point I.2.1) is immersed in a solution of acrylic acid, water (60/40) and 0.1% by mass of Mohr salt in a radiografting tube and nitrogen bubbling is then carried out for 15 mins. Mohr salt was used in order to limit homopolymerization of acrylic acid. The tube is subsequently sealed and is placed in a bath at 60° C. for 1 hour. The obtained membrane was then extracted from the solution and cleaned with water and extracted with boiling water by means of a Sohxlet apparatus for 24 hours. It was then dried for 12 hours under high vacuum.

The radiografting rate was calculated with the following ratio: Y_{w}=(W_{f}−Wᵢ)/Wᵢ (%) wherein W_{f} and Wi represent the weight of the membrane after and before grafting of the vinyl monomer. The radiografting rate was determined to be 50% by mass. The membrane was analyzed by Fourier transform infrared spectrometry in the ATR mode. The specific vibration band of poly(acrylic acid) at 1,703 cm⁻¹ was observed.

I.2.4. Sulfonation of PVDF-g-PS Membranes.

The PVDF-g-PS membrane was immersed in a dichloromethane solution for 20 mins at room temperature so that the membrane is inflated. The membrane is subsequently immersed in a 10% chlorosulfonic acid solution in dichloromethane at room temperature for 30 mins. The membrane is then rinsed twice with dichloromethane (2×50 mL) and is then immersed in a 1 M sodium hydroxide solution at room temperature for 2 hours. In order to re-acidify the membrane, it is rinsed twice in deionized water (2×100 mL) and then immersed in a 1 M sulfuric acid solution at room temperature for 3 hours. After 3 rinsings in deionized water (3×100 mL), the obtained membrane was dried in vacuo at 50° C. for 12 hours. The membrane was analyzed by Fourier transform infrared spectrometry in the ATR mode. The specific vibration band of the SO₃ group at 1,029 cm⁻¹ was observed.

I.2.5. Sulfonation of PVDF-g-PAA membranes

The PVDF-g-PAA membrane was immersed in a 100% chlorosulfonic acid solution at room temperature for 6 hours. The membrane is then rinsed twice with dichloromethane (2×50 mL), in tetrahydrofurane (2×50 mL), in ethanol (2×50 mL) and then in deionized water (2×50 mL). In order to re-acidify the membrane, it is immersed in a 1 M sulfuric acid solution at room temperature for 3 hours. After 3 rinsings in deionized water (3×100 mL), the obtained membrane was dried in vacuo at 50° C. for 12 hours. The membrane was analyzed by Fourier transform infrared spectrometry in the ATR mode. The specific vibration band of the SO₃ group at 1,029 cm⁻¹ and of the group C═O of poly(acrylic acid) at 1,703 cm⁻¹ were observed.

I.2.6. Determination of the Ion Exchange Capacity (IEC) of PVDF-g-PS-SO₃H and PVDF-g-PAA-SO₃H Membranes.

The membranes were immersed in a 1 M NaCl solution for 24 hours at room temperature. The solution was titrated with a 0.01 M sodium hydroxide solution by using phenolphthalein as a colored indicator. The IEC is then determined with the following formula: IEC (mequiv·g⁻¹)=(V.N_{OH})/m with V being the volume of NaOH at equivalence, N_{OH} the normality of the sodium hydroxide solution and m the total mass of the membrane. The IEC of the PVDF-g-PS-SO₃H membrane was evaluated to be 2.97 mequiv·g⁻¹ of proton exchange functions. The IEC of the PVDF-g-PAA-SO₃H membrane was evaluated to be 3 mequiv·g⁻¹ of proton exchange functions.

### II. A Method for Modifying the Surface of the Membranes According to the Present Invention

The grafting of the film of the polyaniline type was carried out in air and at room temperature in the following way: p-phenylenediamine is solubilized at 0.1 M in a solution of hydrochloric acid with a pH of 0.3 (0.5 M HCl). In order to generate the mono-aryl diazonium salt, 5 mL of a 0.1 M sodium nitrite solution were added dropwise into the same volume of a solution of p-phenylenediamine. After homogenization of the solution, 0.5 g of iron filings are added in order to generate the reaction for reducing the salt. The solution generates a foam of nitrogen bubbles (stemming from the reduction of the diazonium salt) and of hydrogen bubbles (due to attack of the iron filings in the acid medium).

After a few instants, the membrane (3×3 cm) is introduced. The membrane is maintained for 90 mins in the solution without any further action and then it is withdrawn and rinsed by soaking in an acid HCl solution, pH=0.3, and then with a salted NaCl solution (30 g/l) and then with deionized water in an ultrasonic bath for 120 mins.

### III. Techniques Used for Characterizing the Modified Membranes According to the Present Invention

III.1. Spectroscopic Studies.

The SEM images were recorded on an SEM-FEG (Field Emissions Gun) Hitachi 54500 electron microscope.

The IR spectra were recorded on a Vertex 70 Bruker spectrometer with an ATR Pike-Miracle accessory. The detector is an MCT (Mercury-Cadmium-Telluride) detector cooled with liquid nitrogen. The spectra were acquired with 256 scans with a resolution of 2 cm⁻¹. The XPS recordings were accomplished on an a KRATOS Axis Ultra DLD with a AlKα source at 1,486.6 eV. The transition energy was set to 20 eV for the core levels.

III.2. Ion exchange capacity.

Membrane samples of known weights are converted into the Na⁺ form by stirring them in a 1 M NaCl solution. The membranes are then washed and set into absorption equilibrium in a 1.0 M HCl solution for 24 hours at 25° C. They are again rinsed with distilled water in order to totally draw out sorbed HCl and finally placed in a 1 M NaCl solution in order to obtain the exchange reaction between the H⁺ ions bound to the sulfonate sites and the Na⁺ ions in the external NaCl solution. The amount of protons in the obtained solution is estimated by acid-basic titration (DMP Titrino Metrohm) and the ion exchange capacity Cₑₓ is expressed as an amount of H⁺ ions (mmol) per gram of dry membrane.

III.3. Transport Index.

The electrodialysis cell consists of two compartments. The membrane is placed in a circular orifice between both compartments. The seal is made by circular flat gaskets. The apparent area of the membrane is 6 cm². Two plates of platinum-plated titanium are used as anode and cathode and placed at the ends of both compartments. The anodic compartment contains 250 mL of a solution consisting of 0.25 M NiSO₄ and 0.25 M H₂SO₄. The cathodic compartment contains 25 mL of a solution only containing 0.5 M H₂SO₄. A current of 60 mA is applied through the cell for 30 mins with a 1286 Solartron potentiostat controlled by the software package Corrware. The amounts of nickel and of protons are checked by atomic absorption spectroscopy and a titrator (DMP Titrino Metrohm).

III.4. Ion Exchange Isotherm.

The membranes are first of all immersed for 24 hours in 0.5 M H₂SO₄. After drying on a paper absorbing sulfuric acid deposited at the surface, the membranes are immersed for 24 hours with stirring in a x N NiSO₄ and 0.5 NH₂SO₄ solution (with x being equal to 0.05; 0.1; 0.2 and 0.5) so as to be charged with ions up to equilibrium. The membranes are then extracted from the solution, buffered with absorbing paper, and then again immersed in a 1 M NaCl solution for 24 hours in order to exchange and draw out all the hydrogen and nickel ions. The amounts of nickel released in the solution are determined by atomic absorption spectroscopy.

III.5. Resistance of the Membranes.

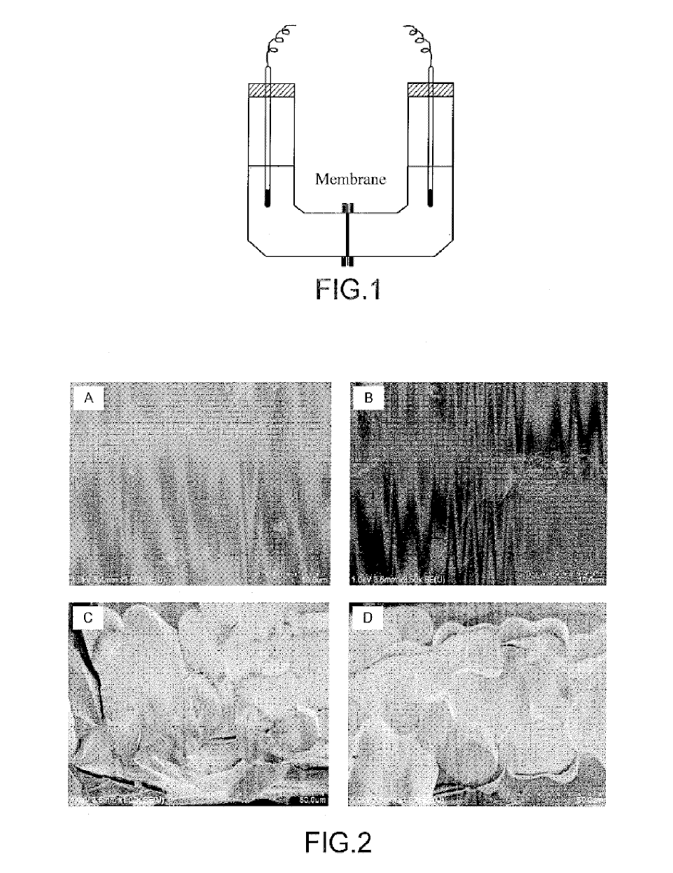

The values of the electric resistances of membranes balanced in given solutions are measured by electrochemical impedance spectroscopy (EIS) by using the mercury cell (FIG. 1). In order to collect this information, platinum wires are immersed in mercury in direct contact with the membrane and consequently form the measurement electrodes. The effective contact area of the membrane with the mercury is 0.866 cm².

By installing the Solartron 1255 HF Frequency response analyser and SI 1286 Electrochemical Interface equipment of the same corporation, the program Zplot of Scribner Associates may store the values of z for frequencies ranging from 1 Hz to 100,000 Hz. The representation of the results is accomplished in the Argand diagram.

The values of electric resistances of the equilibrated membranes in given solutions of sulfuric acid are measured by electrochemical impedance spectroscopy (EIS). The cell consisting of two compartments is conditioned with an equivalent volume of mercury in order to put the whole surface of the membrane in contact. The electrical contacts with the mercury are assumed by platinum/palladium wires. An AC current of variable frequency is used for conducting the analysis by EIS. An impedance diagram defined between frequencies from 1 Hz to 100 kHz allows the resistance to be defined in the high frequency portion. The measurements are made by an assembly 1286 (potentiostat)-1255 (frequency analyzer) from Solartron controlled by the Zview software package.

### IV. Results and Discussions

IV.1. Characterization of the Layer of the Polyaniline Type at the Surface of the VMC Membrane.

The grafting of the layer of the polyaniline type on the VMC membrane is achieved according to the operating mode shown in point II. The chemical principle is illustrated on Scheme 2 hereafter. (a) Addition of one equivalent of NaNO₂ leads to the conversion of only one of the two aminated groups of the diamine molecule into a diazonium salt. It is important to specify that the acid medium allows protection of the diazonium salts formed from the remaining amine functions which are somewhat protected. This contributes to improving the grafting and covering rate of the layer. (b) Chemical reduction of the diazonium salts at the surface of the iron particles leads to the formation of corresponding radical species, (c) these highly reactive species are grafted by a radical addition mechanism on the surrounding surfaces, (d) a growth mechanism for the layer is possible and may lead to thicknesses of a few nanometers.

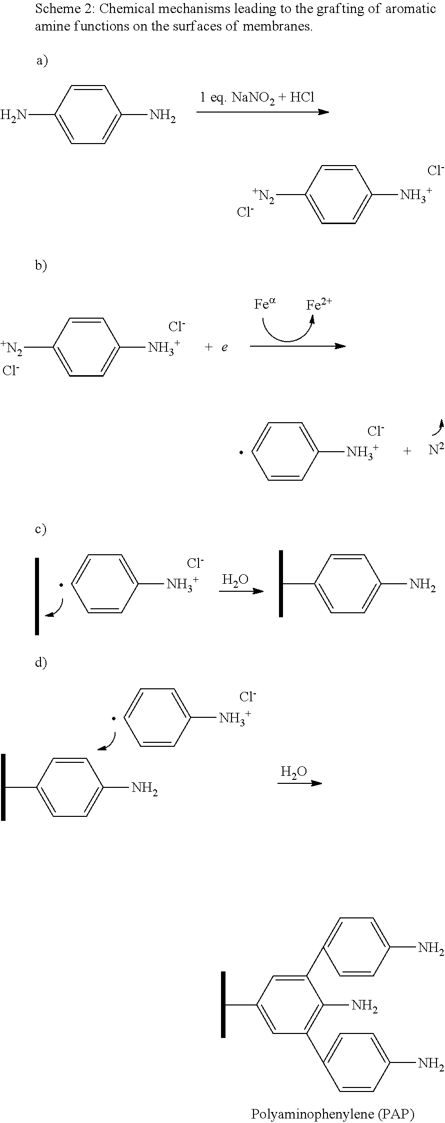

The membrane at the end of the reaction is first of all rinsed with 0.5 M hydrochloric acid in order to remove any trace of iron particles. It is then conditioned in a 1 M NaCl solution for exchanging the protons with sodium in the volume of the membrane. Finally, the membrane is rinsed with deionized water. It should be specified that at this stage, the surface amine groups are neutralized. They will become charged groups intended for repelling the multivalent ions when they will be under the conditions of use i.e. in an acid medium for which the pHs are sufficient for making the conjugate acid form of the amine base. The pKa of aniline is 4.63 i.e. the usual pHs of the acid effluents will always be below this value.

The SEM image of the surfaces and of the sections of virgin membranes and modified by a film of the polyaniline type are shown in FIG. 2. The presence of the film of the polyaniline type is visible on the images showing the surface of the membranes by the appearance of a slight orange skin aspect (FIG. 2B) which is not visible on the virgin surface (FIG. 2A). The images of the membrane section do not actually allow observation of an additional layer (FIGS. 2C and 2D). This expresses the fact that the modification is extremely superficial.

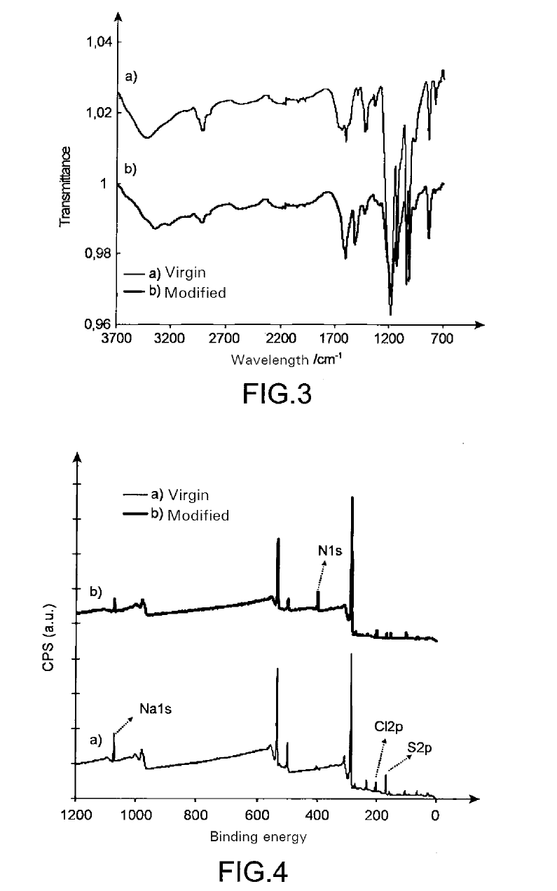

FIG. 3 shows the IR spectra before and after modification. The spectrum of the non-modified VMC membrane (i.e. virgin) is characterized by the 1,171 cm⁻¹ band which corresponds to the S═O vibration. Those corresponding to the vibrations of —SO₃⁻ groups are observed at 1,008 and 1,037 cm^{-1 [}12]. After modification with a film of the polyaniline type, the bands associated with the —SO₃⁻ groups are always visible even if they have slightly decreased in intensity. New bands at 1,510 and 1,610 cm⁻¹ and also at 3,350 cm⁻¹ are respectively ascribed to NH₂ vibrations with NH deformation and elongation. The general aspect of the spectrum corresponds to the presence of the membrane and to a thin layer of the polyaniline type as this may be observed on a metal surface. IR analysis is conducted, taking into account the ATR method, over a thickness from 1 to 3 μm relatively to the surface of the membrane.

The virgin and modified membranes are also analyzed by XPS. This time, the analysis of the surface is accomplished on a nanometric scale (10-20 nm). As this may be seen in FIG. 4, the virgin VMC membrane shows peaks at 1,072 eV (Na1s), 977 eV (O KLL Auger peak), 532 eV (O1s), 497 eV (Na KLL Auger peak), 228 eV (S2s) and 169 eV (S 2p) characteristics of sulfonate groups as well as peaks at 271 eV (C12s), 200 eV (C12p) and 285 eV (C1s) ascribed to the polyvinyl chloride (PVC) backbone [12, 18].

An attenuation of the chlorine and sulfur peaks and the appearance of a peak at 400 eV due to nitrogen are notably observed between the virgin and modified membrane. These two observations express the presence of a thin film of the polyaniline type present on the surface of the membrane. The film may be estimated to have a thickness of a few nanometers. FIG. 3 shows the N is peak centered on 400 eV in good agreement with an NH₂ group.

The stability of the grafted layer is demonstrated by the fact that the spectra shown above are systematically obtained after having been subject to ultrasonic waves for a long time. Some samples have even remained for a week in 0.5 M hydrochloric acid.

It was regularly shown that cation exchange membranes modified by a cationic surface layer are preferentially permeable to cations of low valency rather than to cations of higher valency. At the same time, these membranes are more permeable to small hydrated cations rather than to the largest because of electrostatic repulsions and of the small size of the pores.

IV.2. Characterization of the Layer of the Polyaniline Type at the Surface of the PVDF-g-PAA Membrane.

The grafting of the layer of the polyaniline type on the PVDF-g-PAA membrane is accomplished according to the operating mode shown in point II and described in paragraph IV.1.

The membrane at the end of the reaction is first of all rinsed with 0.5 M hydrochloric acid in order to remove any trace of iron particles. It is then conditioned in a 1 M NaCl solution in order to exchange protons with sodium in the volume of the membrane. Finally, the membrane is rinsed with deionized water. It should be specified that at this stage, the surface amine groups are neutralized. They will become charged groups intended to repel multivalent ions when they will be under the conditions of use i.e. in an acid medium for which the pHs are sufficient for making the conjugate acid form of the amine base. The pKa of aniline is 4.63 i.e. the usual pHs of acid effluents will always be below this value.

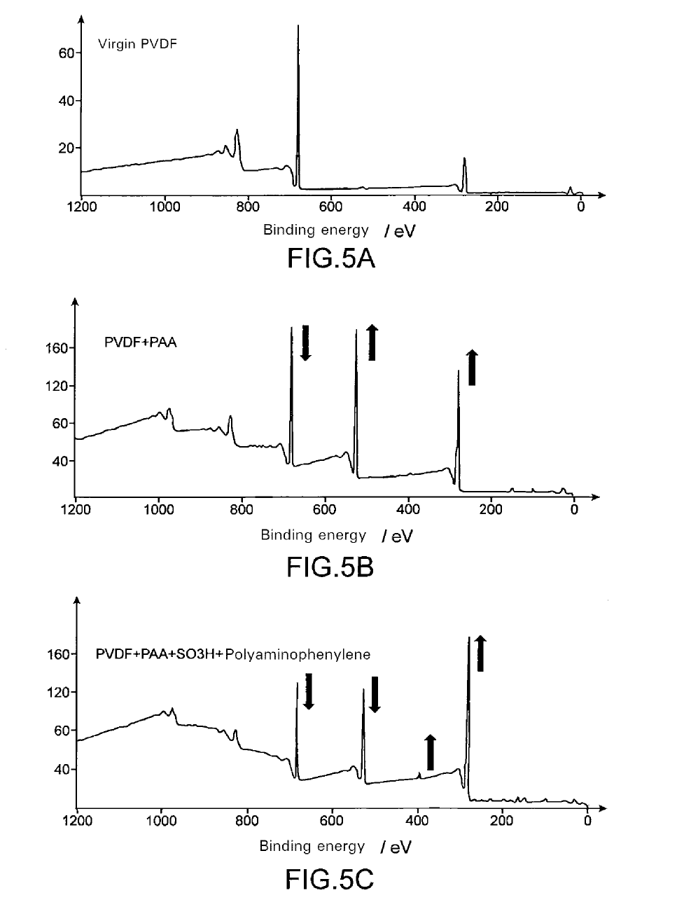

The virgin and modified membranes are analyzed with XPS. As this may be seen in FIG. 5, the virgin PVDF membrane (FIG. 5A) shows a double peak centered on 287 eV. The first at 285 eV corresponds to the carbons (C1s) bearing the hydrogen atoms of PVDF and the second around 290 eV corresponds to the carbons bearing the fluorine atoms of PVDF. The peak centered on 685 eV directly corresponds to the fluorine atoms of PVDF (F1s).

The grafting of the PVDF membrane by PAA, PVDF-g-PAA, is characterized (FIG. 5B) by the appearance of an intense band at 532 eV associated with oxygen atoms (O1s) of PAA. The carbon peak in majority becomes centered on 285 eV. In relative intensity, the peak F1s decreases in intensity because of the presence of the PAA film which covers the PVDF.

The modification with the thin film of the polyaniline type (FIG. 5C) is mainly expressed by the appearance of the peak N1s centered on 400 eV and by the relative decrease of the F1s and 01s peaks. The film may be estimated to have a thickness of a few nanometers.

The stability of the grafted layer is demonstrated by the fact that the spectra shown above are systematically obtained after being subject for a long time to ultrasonic waves. Some samples have even remained for one week in 0.5 M hydrochloric acid.

It was regularly shown that the cation exchange membranes modified by a cationic layer at the surface are preferentially permeable to cations of low valency rather than to cations of a higher valancy. In the same way, these membranes are more permeable to small hydrated cations rather than to the largest because of the electrostatic repulsions and of the small size of the pores.

IV.3. Improvement in the Selectivity to Hydrogen Ions.

During the electrodialysis process, the transport number of the hydrogen ions and of the nickel ions, through the membrane may be determined from the composition of the anodic compartment before and after electrodialysis, according to the equation:

$${\overline{t}}_{M} = \frac{F ( {N}_{0} - {N}_{t} )}{I \times t}$$

wherein F is Faraday's constant; N₀, Nₜ are the initial and final concentrations of ion M in the anodic compartment, I is the total applied current and t represents the electrodialysis time.

Otherwise, the specific permselectivity between the Ni²⁺ and H⁺ cations, T_{H}_{⁺}^{Ni}^{²⁺} which is called the transport number of cation Ni²⁺ relatively to H⁺ is defined in the following equation:

$${T}_{{H}^{+}}^{{Ni}^{2 +}} = \frac{{\overline{t}}^{{Ni}^{2 +}} / 2 {c}_{{Ni}^{2 +}}}{{\overline{t}}_{{H}^{+}} / {c}_{{H}^{+}}}$$

wherein c_{Ni}_{²⁺} and c_{H}_{⁺} are respectively the concentrations of the Ni²⁺ and H⁺ cations on the surface of the membrane on the side of the desalted solution during electrolysis.

The comparison between the values of T_{H}_{⁺}^{Ni}^{²⁺} of 0.056 and of 0.0066 for the virgin membrane and the modified membrane shows the increase in selectivity towards protons. Such results are comparable with those obtained with the other ion exchange membranes, selective to the protons modified by traditional methods [2,4,19].

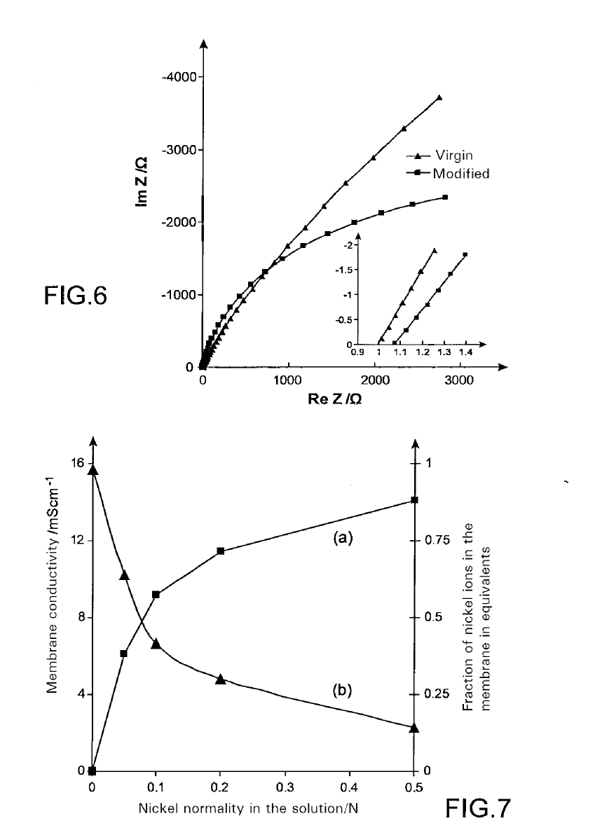

It is clear that modification of the membrane does not only improve selectivity but may also lead to a loss of conductivity and thereby affect the efficiency of the electrodialysis. It is therefore important to study the resistance of the membrane. In this work, the resistance of the membrane after equilibrium in the 0.25 M H₂SO₄ solution is determined by EIS in the cell with compartments filled with mercury. The determination of the value is inferred from the Nyquist diagram of the virgin and modified surface which has the general aspects seen in FIG. 6.

By taking into account the area of the membrane (0.866 cm²), the electric resistance of the virgin and modified membranes in contact with 0.25 M sulfuric acid may be inferred. It is noted that the electric resistance slightly increases from 0.86 to 0.93 ohm·cm² after modification, i.e. by 8%.

Chapotot [19] reports that the electric resistance of a CRA membrane modified by a layer of polyetheleneimine increases from 2.1 to 4.1 ohm·cm², i.e. by almost 100%. Within the scope of the present invention, the increase in the resistance value seems to remain very small because of the small thickness of the added layer. This assumption is in good agreement with the study on the ion exchange capacity. As desired, the thin layer of the polyaniline type does not affect the ion exchange capacity of the modified membrane relatively to the virgin membrane.

It is measured:
the ion exchange capacity of a virgin membrane is measured to be 2.13 mmol·equiv./g
the ion exchange capacity of a modified membrane is measured to be 2.11 mmol·equiv./g

Further, the value of 0.93 ohm·cm² obtained in this work on the VMC membrane may be compared with the value of 0.96 ohm·cm^{2 [}3] of the commercial membrane CMS. The latter which is frequently used for the treatment of effluents from metallization industries [2,3,20] is modified at the surface so as to improve its selectivity for monovalent cations and has the same polystyrene-divinylbenzene structure as the VMC membrane.

IV.4. Exchange Equilibrium of Hydrogen and Nickel in the Membrane.

It was shown that the presence of a thin layer of the polyaniline type grafted at the surface of the membrane gives it performing properties for separating the protons from a mixed solution consisting of sulfuric acid and nickel sulfate. An investigation on the transport competition between protons and nickel ions in the membrane requires a better description of the exchange equilibria between proton and nickel. The investigations conducted by the inventors on the absorption properties of the membrane in the presence of sulfuric acid were extended with different nickel sulfate concentrations.

In order to express the ion exchange isotherm between the external solution and the membrane, the equivalent faction f_{M}_{²⁺} should be defined in the equilibration solution and f̅_{M}_{²⁺} in the membrane for the H⁺—Ni²⁺ system should be defined as follows:

$${f}_{{Ni}^{2 +}} = \frac{2 {c}_{{Ni}^{2 +}}}{2 {c}_{{Ni}^{2 +}} + {c}_{{H}^{+}}}$$

$$and$$

$${\overline{f}}_{{M}^{2 +}} = \frac{2 {\overline{c}}_{{Ni}^{2 +}}}{2 {\overline{c}}_{{Ni}^{2 +}} + {\overline{c}}_{{H}^{+}}}$$

wherein c_{M}_{²⁺} and c̅_{M}_{²⁺} are ion concentrations (mol/cm³) in the solution and in the membrane respectively.

In a previous work [3], it was shown that the electrolytic ion which is not exchanged, entering the membrane phase, is negligible in comparison with the exchange capacity. In this case, the equilibrium conditions of the obtained charges are:

c̅_{H}⁺+2 c̅_{Ni}_{²⁺}= c̅ₑₓ,

with c̅ₑₓ as the concentration of fixed ionic sites in the membrane.

FIG. 7 describes the ion exchange isotherm for the modified membrane. It is observed that the absorbed amount of nickel is slightly greater in the modified membrane than in the virgin membrane.

In reality, with an external solution containing an equivalent fraction of 0.5, an absorbed equivalent fraction of 0.88 is obtained in the modified membrane and of 0.94 in the virgin membrane [3]. The observed difference between both membranes is due to the presence of the positively charged layer which reduces the transfer velocity of divalent nickel ions. In another way, the conductivity of the membrane κₘ may be determined from the mobility of the hydrogen and nickel ions in the membrane in the following way:

κₘ=F c̅ₑₓ(ū_{M}_{²⁺}−ū_{H}_{⁺}) f̅_{M}_{²⁺}+F c̅ₑₓū_{H}_{⁺}

an equation wherein ūᵢ is the mobility (cm²s⁻¹V⁻¹), c̅ᵢ is the total concentration of ions i in the membrane phase (mol/cm³).

In the present work, the membrane conductivity κₘ is calculated by using the following relationship:

$${κ}_{m} = \frac{d}{R A}$$

wherein R is the resistance of the membrane and d and A are the thickness and the exposed surface of the membrane (A=0.866 cm²), respectively in the cell with two compartments. The experimental values of the conductivity are plotted on curve (b) of FIG. 7.

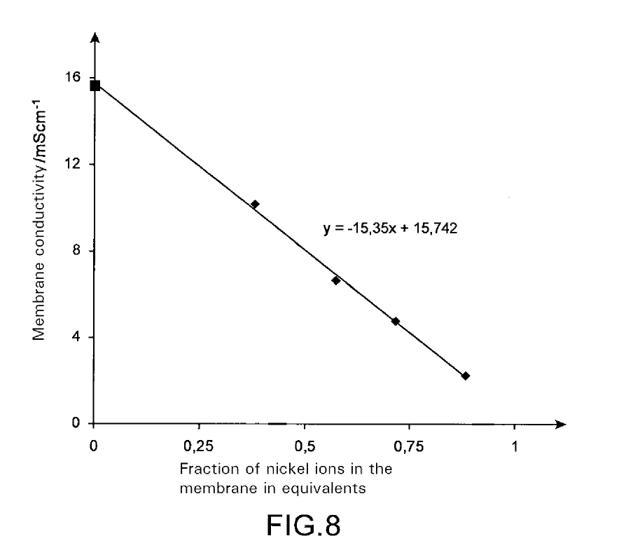

The equation κₘ=F c̅ₑₓ(ū_{M}_{²⁺}−ū_{H}_{⁺}) f̅_{M}_{²⁺}+F c̅ₑₓū_{H}_{⁺} shows that the membrane conductivity changes linearly as a function of the equivalent nickel fraction in the membrane. The line of FIG. 8 confirms the validity of the equation above. From parameters given in the Figure, it is possible to calculate the value of the ratio

$$\frac{{\overline{u}}_{{H}^{+}}}{{\overline{u}}_{{Ni}^{2 +}}} ,$$

which is 40.2 for the modified membrane.

The experiments made with the virgin VMC membrane give much lower values of the mobility ratio of the order of 7.4. This value expresses the fact that the virgin membrane does not exhibit any specific selectivity for either monovalent or multivalent ions. This is a value similar to those obtained with non-selective membranes.

On the contrary, the value of 40.2 obtained with the modified membrane is comparable with those of 39.8; 37.9 or 38.7 for Ni²⁺, Cu²⁺ or Zn²⁺ respectively and obtained with commercial high selectivity membranes such as CMS and reported in the literature [3,20].

Mobility ratio H⁺/Ni²⁺ of a modified VMC is 40.2

Mobility ratio H⁺/Ni²⁺ of a virgin VMC is 7.4

### V. Conclusion

A thin layer of a polyaniline type polymer was grafted on the surface of a cation exchange membrane by a very simple method, based on diazonium salts in order to improve selectivity to monovalent ions.

The presence of a positively charged layer on the surface of the membrane placed in an acid medium leads to strong selectivity towards protons.

It is remarkable to note that the thereby made modification only modifies the selectivity properties of the membrane without altering either the ion exchange capacity or the electric resistance of the membrane which are fundamental parameters for the efficient operation of a membrane in electrodialysis. The positive layer reduces the amount of nickel penetrating into the membrane and influences the competition in the electric transport phenomenon between the protons and the nickel ions.

### REFERENCES

[1] Roux-de Balmann and Casademont, 2006, [symbol] Electrodialyse [symbol] , Techniques de l'Ingénieur, J 2840;
[2] Taky et al., 1996, [symbol] Transport properties of a commercial cation-exchange membrane in contact with divalent cations or proton-divalent cation solutions during electrodialysis [symbol] , Hydrometallurgy, Vol. 43, p. 63;
[3] Tuan et al., 2008, [symbol] Absorption equilibrium and permselectivity of cation exchange membranes in sulfuric acid, sodium chloride and nickel sulfate media [symbol] , J. Membr. Sci., Vol. 323, p. 288;
[4] Boulehid, 2007, [symbol] Elaboration et caractérisation d'une membrane cationique monoselective par modification chimique d'un film ETFE [symbol] , PhD dissertation, Université Libre de Bruxelles;
[5] Vallois et al., 2003, [symbol] Separation of H⁺/Cu²⁺ cations by electrodialysis using modified proton conducting membranes [symbol] , J. Membr. Sci., Vol. 216, p. 13;
[6] Sata, 1978, [symbol] Modification of properties of ion-exchange membranes. IV. Change in transport properties of cation exchange membranes by various polyelectrolytes [symbol] , J. Polym. Sci., Polym. Chem. Ed. 16, p. 1063;
[7] Katsube and Asawa, 1969, [symbol] Electric potential drop across cation-exchange membranes with high permselectivity to univalent cations in electrodialytic concentration of sea water [symbol] , Rep. Res. Lab., Asahi Glass 19, p. 43;
[8] Sata and Izuo, 1989, [symbol] Modification of properties of ion-exchange membranes. X. Formation of polyethyleneimine layer on cation-exchange membrane by acid-amide bonding [symbol] , Angew. Makromol. Chem., Vol. 171, p. 101;
[9] Nagarale et al., 2004, [symbol] Preparation and electrochemical characterization of cation-and anion-exchange/polyaniline composite membranes [symbol] , J. Colloid Interface Sci., Vol. 277, p. 163;
[10] Gohil et al., 2006, [symbol] Preparation and characterization of monovalent ion selective polypyrrole composite ion-exchangemembranes [symbol] , J. Membr. Sci., Vol. 280, p. 210;
[11] Tan et al., 2002, [symbol] Chemical modification of a sulfonated membrane with a cationic polyaniline layer to improve its permselectivity [symbol] , Electrochem. Solid-State Lett., Vol. 5, p. E55;
[12] Chamoulaud and Belanger, 2004, [symbol] Chemical modification of the surface of a sulfonated membrane by formation of a sulfonamide bond [symbol] , Langmuir, Vol. 20, p. 4989;
[13] U.S. Pat. No. 5,840,192 (Université Libre de Bruxelles) published on 24 Nov. 1998;
[14] Takata et al., 1996, [symbol] Modification of transport properties of ion exchange membranes, XIII^{a}, Surface-modified cation exchange membranes prepared from polyamines and a copolymer membrane containing p-styrenesulfonyl chloride [symbol] , Angew. Makromol. Chem., Vol. 236, p. 67;
[15] Sivaraman et al., 2007, [symbol] Electrochemical modification of cation exchange membrane with polyaniline for improvement in permselectivity [symbol] , Electrochimica Acta, Vol. 52, p. 5046;
[16] International application WO 2008/07802 (CEA) published on Jul. 3, 2008;
[17] Tuan et al., 2006, [symbol] Properties of CMV cation exchange membranes in sulfuric acid media [symbol] , J. Membr. Sci., Vol. 284, p. 67;
[18] Tan et al., 2003, [symbol] Characterization of a Cation-Exchange/Polyaniline Composite Membrane [symbol] , Langmuir, Vol. 19, p. 744;
[19] Chapotot et al., 1995, [symbol] Electrotransport of proton and divalent cations through modified cation-exchange membranes [symbol] , J. Electroanal. Chem., Vol. 386, p. 25;
[20] Siali and Gavach, 1992, [symbol] Transport competition between proton and cupric ion through a cation-exchange membrane: I. Equilibrium properties of the system: membrane-CuSO₄+H₂SO₄ solution [symbol] , J. Membr. Sci., Vol. 71, p. 181.

1. A cation exchange membrane consisting in a polymeric cation exchange matrix on the surface of which is(are) grafted at least one group of formula —R₁—(CH₂)m-NR₂R₃ and/or at least one molecule bearing at least one group of formula —R₁—(CH₂)m-NR₂R₃ wherein:
R₁ represents an aryl group;
m represents 0, 1, 2 or 3;
R₂ and R₃, either identical or different represent a hydrogen or an alkyl group.

2. The cation exchange membrane according to claim 1, characterized in that said aryl group is an aromatic or heteroaromatic carbonaceous structure, optionally mono- or poly-substituted, consisting of one or more aromatic or heteroaromatic rings each including from 3 to 8 atoms, the heteroatom(s) may be N, O, P or S.

3. The cation exchange membrane according to claim 1, characterized in that said aryl group is a phenyl at least substituted with a group of formula (CH₂)m-NR₂R₃ directly bound to one of the atoms of the phenyl.

4. The cation exchange membrane according to claim 1, characterized in that said groups R2 and R3, either identical or different, are selected from the group consisting of a hydrogen, a methyl, an ethyl or a propyl.

5. The cation exchange membrane according to claim 1, characterized in that said group of formula —(CH2)m-NR2R3 substituting the aryl group R1 is selected from the group consisting of —NH₂, —CH₂—NH₂, —(CH₂)₂—NH₂, —N(CH₃)₂, —CH₂—N(CH₃)₂, —(CH₂)₂—N(CH₃)₂, —N(C₂H₅)₂, —CH₂—N(C₂H₅)₂ and —(CH₂)₂—N(C₂H₅)₂.

6. The cation exchange membrane according to claim 1, characterized in that said grafted molecule is a polymeric structure.

7. The cation exchange membrane according to claim 6, characterized in that said polymeric structure is a (co)polymer mainly derived from several monomer units, either identical or different, of formula R₁[(CH₂)m-NR₂R₃]— with R₁, R₂, R₃ and m as defined in claim 1.

8. The cation exchange membrane according to claim 1, characterized in that said polymeric matrix is nano structured.

9. The cation exchange membrane according to claim 1, characterized in that said polymeric matrix comprises, in its thickness, substantially cylindrical zones comprising polymeric chains covalently bound to the polymer forming the matrix and selected from:
polymeric chains comprising a main chain, at least one portion of the carbon atoms of which is bound both to a —COOR group and to a —SO₃R or PO₃R₂ group, R representing a hydrogen, a halogen, an alkyl group or a cationic counter ion;
polymeric chains comprising a main chain comprising phenyl pendant groups, at least one portion of these groups of which comprises at least one hydrogen atom substituted with a —SO₃R or —PO₃R₂ group, R having the same meaning as the one given above, and
mixtures thereof.

10-11. (canceled)

12. A method for preparing a cation exchange membrane according to claim 1, consisting in grafting on a polymeric matrix as described earlier at least one group of formula —R₁—(CH₂)m-NR₂R₃ with R₁, R₂, R₃ and m as defined in claim 1 and/or at least one molecule bearing at least one such group.

13. The method according to claim 12, characterized in that it consists in reacting on said polymeric matrix, by chemical radical grafting, a cleavable aryl salt bearing at least one group of formula —(CH₂)m-NR₂R₃ with m, R₂ and R₃ as defined in claim 1, directly bound to a (hetero)aromatic ring.

14. The method according to claim 13, characterized in that said cleavable aryl salt is of the following formula (I):
R₂R₃N—(CH₂)m-R₁—N₂⁺,A⁻ (I)
wherein:
A represents a monovalent anion and
m, R1, R2 and R3 are as defined in claim 1.

15. The method according to claim 12, characterized in that it comprises the following steps:
a) optionally converting a precursor of a cleavable aryl salt bearing at least a group of formula —(CH₂)m-NR₂R₃ directly bound to a (hetero)aromatic ring present in a solution S into said corresponding cleavable aryl salt;
b) subjecting a cleavable aryl salt bearing at least one group of formula —(CH₂)m-NR₂R₃ directly bound to a (hetero)aromatic ring, optionally obtained following step (a), present in a solution S, under non electrochemical conditions so as to generate a radical entity from said cleavable aryl salt;
c) putting said polymeric matrix in contact with the radical entity obtained in step (b) present in said solution S by means of which grafting of a group of formula —R₁—(CH₂)m-NR₂R₃ and/or of a polymeric structure bearing at least one such group on said polymeric matrix is achieved,
m, R1, R2 and R3 being as defined in claim 1.

16. A method for electrodialysing a solution, comprising the steps consisting in:
putting a cation exchange membrane in contact with said solution,
submitting said solution to an electric field.

17. The method according to claim 16, characterized in that said solution is selected from the group consisting of brackish water, spring water, drinking water, sea water, an industrial effluent, a solution from the agrifood industry or a solution from the fine chemical industry or from the pharmaceutical industry.
